(19) United States
(12) Patent Application Publication
(10) Pub. No.: US 2005/0121496 A1
(43) Pub. Date: Jun. 9, 2005

(54) Apparatus for immobilizing a solid solder element to a contact surface of interest

(76) Inventors: Kevin C. Farrell, Wellington, FL (US); Edwin L. Bradley, Coral Springs, FL (US); Hal R. Canter, Weston, FL (US); Gene Kim, Plantation, FL (US); David H. McClintock, Davie, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 10/786,578

(22) Filed: Feb. 23, 2004

Related U.S. Application Data
(60) Provisional application No. 60/527,586, filed on Dec. 5, 2003.

(51) Int. Cl. B23K 37/04

(52) U.S. Cl. 228/49.1; 228/49.5

(57) ABSTRACT

A solid solder element (106), such as a solder perform, is attached onto a contact surface of interest (102), such as a heat sink using and adhesive material (104). Placement of the adhesive material overcomes alignment and registration issues that may interfere with good contact to components (108), such as transistors, during the manufacturing/assembly process, such as a reflow process.

### CROSS REFERENCE TO RELATED APPLICATIONS

This application claims the benefit of U.S. Provisional Application No. 60/527,586 filed Dec. 5, 2003 and assigned to Motorola, Inc.

### TECHNICAL FIELD

This invention relates in general to the assembly of components and more specifically to a means of attaching and immobilizing a solid solder element to a contact surface of interest.

### BACKGROUND

A solder preform is a solid solder element used to facilitate attachment of a component, such as a microelectronic, to a solderable contact surface. For example, a solder preform can be used to facilitate the attachment and alignment of a radio frequency power amplifier (RFPA) transistor to a heat sink.

It is important to achieve good contact between a solder preform and the contact surface of interest, as well as immobilize the preform during the reflow process in order to achieve good alignment and registration of the eventual attachment of the component. However, designers are challenged by tight tolerances in the thickness/stacking direction during assembly. In the case of the RFPA transistor, the transistor is typically placed on a printed circuit board, followed by the solder preform element, then by the heatsink, with all three parts being stacked on top of one another prior to reflow. A misplaced solder preform (misplaced by pick and place machine) may cause both heatsink and RFPA transistor movement during reflow resulting in a non-flat, improperly reflowed, and/or improperly aligned solder interface to the transistor.

Accordingly, there is a need for an effective means of placing a solid solder element, such as a solder preform, that limits the movement of stacked parts during the solder reflow process.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 is an assembly of a solid solder element attached to a contact surface in accordance with the present invention.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

In accordance with the present invention, there is provided herein a means of attaching a solid solder element (such as a solder perform) onto a contact surface of interest (such as a heat sink). The attachment means provided by the present invention overcomes alignment and registration issues that may interfere with good contact to microelectronic components (such as transistors), especially during the manufacturing/assembly process, such as reflow. For the purposes of this application the solid solder element may be a solder perform or other similar soldering interface attachment mechanism.

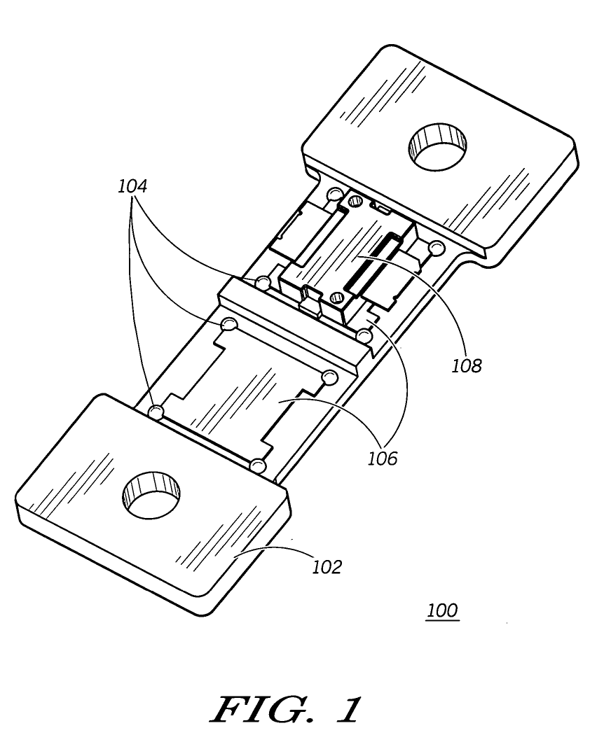

Referring to FIG. 1, there is shown an assembly of a solid solder element attached to a desired contact surface in accordance with the present invention. Assembly 100 includes a desired contact surface 102, shown here as a heat sink. In accordance with the present invention, an adhesive material 104 is used to attach a solid solder element 106 to a contact surface of interest. The adhesive material 104 is preferably formed of an organic polymeric material described in further detail below. The adhesive material 104 is placed away from the affected area of attachment, preferably by pinning the corners of the solid solder element 102 to overlap to the contact surface 102. The preferred placement approach dispenses the adhesive in the form of “glue dots”. This process achieves good contact between the solder element 106 and the contact surface of interest, as well as immobilizes the solder element during the reflow process, thereby providing good alignment and registration for the eventual attachment of microelectronic components, such as transistor 108.

The adhesive material 104 provides a means of pre-attaching the solid solder element 106 to the desired contact surface 102. While an adhesive layer could be placed between the solder element and contact surface, the issues of tight stack up tolerances, poor thermal interface, and/or poor electrical conductivity make this an undesirable approach. By applying the adhesive material 104 so as to overlap a portion of the solder element 106 and the contact surface 102, the adhesive material will not be inadvertently mixed with the solder element during reflow. As seen in FIG. 1, the corners of the solder preform 106 do not interfere with stack-up construction of the heatsink/solder preforrn/transistor 102/106/108. The deposition of the adhesive material provides a post (or pinning) solution to immobilize the solder preform 106 during reflow.

As mentioned above, the adhesive material is preferably an organic polymeric material that provides immobilization of the solder element onto the desired contact surface during the reflow process. Selection of the adhesive is based on a variety of parameters including: (1) adhesive/curing chemistry that does not react with nearby or contacted materials; quick curing profile (i.e. lower temperature than the solder profile); preferred viscosity so as to be less liquid-like and more solid-like during the application of the adhesive; withstands the solder reflow temperatures (up to 250 C); requires little to no additional equipment for curing or dispensing; does not interfere electrically with electronic components from a dielectric performance perspective.

Based on the above criteria, the selected adhesive preferably cures under concentrated light (UV or light), or oven cure (which will be below any noticeable solder reaction temperature: under 100° C). A highly viscous adhesive is desirable, for. accurate control of laying down “glue dots” (that overlap and attach the solder preform and the contact surface of interest). To avoid dot registration failures, a placement tolerance can be written into the design/assembly guidelines for the adhesive post solution.

Adhesives with high heat applications, as well as less thermally stable adhesives, can be used. Widely accepted processes such as curing ovens can be used. Examples of the adhesive material include but are not limited to: a light cure adhesive, a room temperature cure 2-part epoxy, a room temperature cure gel cyanoacrylate adhesive, and a heat cured 1-part epoxy. The adhesive material selection is summarized in the following table.

| | | 2 part epoxy | gel | |
|---|---|---|---|---|
| Adhesive | Light cure | (room temp. | cyanoacrylate | 1-part epoxy |
| Type | adhesive | cured) | adhesive | (heat cured) |
| curing profile | 20-30 sec | room | room | 90 C. for |
| | light | temperature | temperature | 90 sec |
| | exposure | | | |
| weight loss | 9% | 3% | 45% | 5% |
| (250 C.) | | | | |
| dispensing | easy | difficult | easy | relatively |
| capability | | | | easy |
| | | | | (pneumatic) |
| reaction with | no | no | no-slight | no |
| component | | | hazing | |
| extra | light | none | none | curing |
| equipment | booth/ | | | oven/ |
| | conveyor | | | conveyor |

To test the thermal stability of the adhesives, a heating profile in a TGA (Thermo-Gravimetric Analyzer) was performed. Based on the selection criterion, the room temperature cure gel cyanoacrylate adhesive and the heated cure 1-part epoxy serve well for the application. Initial testing with the room temperature cure gel cyanoacrylate adhesive and 1-part epoxy showed no failures due to the adhesive. The heated cure 1-part epoxy, mostly to ensure that the loss in weight (45% weight loss for the gel cyanoacrylate adhesive but only 5% for the 1-part epoxy) did not translate into undesirable mechanical properties or premature failures.

The above testing provided a means to immobilize a floating solder preform onto a heat sink, through the use of adhesive glue dots. Using the oven cure (90° C.) 1-part part epoxy, the adhesive immobilized the solder preform onto the heat sink. At post cure the deposited adhesive material maintains geometry and adhesive properties through a temperature of at least 250 C. With proper design guidelines, this prevents failures in building a high power transistor assembly.

While the previous example has been described in terms of attaching a solid older element to a heat sink, the adhesive attachment mechanism of the present invention also has applications in shielding, grounding, and stiffening elements to parts placed on circuit boards and prior to reflow. The solid solder element may be planer or formed. The adhesive may be applied in continuous strips, individual nodules and may be cured at room temperature, elevated temperatures, with ultraviolet exposure, or other appropriate curing means. The attachment approach of the present invention provides location accuracy of a solid solder element and secondary piece part. The robust attachment is consistent part-to-part. The quality of the solder interface is consistent due to preservation of raw materials (no or low cure temperature and no added attachment pressure). Subsequent reflow of mechanical, electrical, or electromechanical components to the solderable substrate via the immobilized solid solder element provides improved alignment and fewer assembly failures in the overall stack up.

Accordingly, adhesive materials can now be used in the attachment of solder elements onto contact surfaces of interest to provide robust attachment and a highly reliable, thermally and electrically conductive interface. The method can be expanded to attach other difficult-to-attach designs, where quality issues of the flux, attachment to curved surfaces, and other potential processing schemes where intimate contact between a solid solder element and the contact surface of interest, may be limited. The solution provided by the contact mechanism of the present invention provides an effective alternative in attaching solid solder elements onto contact surfaces of interest.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. An apparatus for attaching a solid solder element to a solderable substrate, comprising:
an adhesive material applied to a portion of the solid solder element so as to overlap with the solderable substrate outside of a predefined area reserved for subsequent component placement, the adhesive material immobilizing the solid solder element during reflow.

2. An assembly, comprising:
a solderable substrate;
a solid solder element;
a component for coupling to the solderable substrate via the solid solder element during a reflow process; and
an adhesive material for immobilizing the solid solder element to the solderable substrate prior to the reflow process.

3. The assembly of claim 2, wherein the adhesive material is cured prior to the reflow process.

4. An interface apparatus for component attachment, comprising:
a solderable substrate;
a solid solder element; and
an adhesive material for coupling the solid solder element to the solderable substrate, the adhesive material overlapping the solderable substrate and the solid solder element, the adhesive material cured so as to immobilize the solid solder element; and
the component subsequently being coupled to the solderable substrate via the solid solder element during a reflow process.

5. The interface apparatus of claim 4, wherein the component is at least one of mechanical, electrical, and electromechanical components.

6. The interface apparatus of claim 4, wherein the adhesive material is characterized by a predetermined application viscosity, predetermined volume reduction during the reflow process, retention of adhesive qualities during the reflow process, and an inability to mix with the solid solder element during the reflow process.

7. An interface apparatus for component attachment, comprising:
a solderable substrate;
a solid solder element; and
an adhesive material having predetermined geometry and adhesive properties cured so as to couple the solid solder element to the solderable substrate; and
the component subsequently being coupled to the solderable substrate via the solid solder element during a post cure reflow process during which the adhesive material maintains its geometry and adhesive properties.
